(19) United States
(12) Patent Application Publication
(10) Pub. No.: US 2019/0084297 A1
(43) Pub. Date: Mar. 21, 2019

(54) METHODS AND SYSTEMS EMPLOYING LASER SURFACE PREPARATION FOR INKJET PRINTING

(71) Applicant: Global Graphics Software Limited, Cambridge (GB)

(72) Inventors: Eric Worrall, Cambridgeshire (GB); Srikrishna Nudurumati, Cambridge (GB)

(21) Appl. No.: 15/705,967

(22) Filed: Sep. 15, 2017

(51) Int. Cl. B41J 2/045; B41J 2/44

(52) U.S. Cl. CPC B41J 2/04505; B41J 2/04586; B41J 2/442

(57) ABSTRACT

A system for printing on a medium includes a laser to form markings in the medium; at least one printer nozzle to produce droplets for printing on the medium; and at least one computer processor coupled to the laser and at least one printer nozzle. The at least one computer processor is configured to: receive instructions for printing on the medium; direct the laser to form an arrangement of markings in the medium in accordance with the instructions, where each marking extends into the medium; and direct the at least one printer nozzle to deposit at least one droplet of ink in each of a plurality of the markings in accordance with the instructions.

### FIELD

The invention relates to systems and methods for printing and, in particular, inkjet printing. In addition, the invention is related to systems and methods for laser surface preparation for inkjet printing.

### BACKGROUND

A multi-level digital print device can lay down different amounts of colorant at each addressable location on the media using multiple levels for one or more of the colorants. Such devices include, for example, digital inkjet printing devices and electrophotographic (EP, toner) printers.

Several different approaches have been used for the physical application of the colorant to the media. For inkjet devices, for instance, any of the following may be used: (1) The print head moves across the media multiple times, emitting ink drops on every pass. Each location on the media may receive zero, one, or more drops. (2) The media moves beneath a ‘grayscale’ print head, where each nozzle is capable of delivering a variety of different drop sizes on demand. (3) The media moves beneath a series of print heads, each nozzle of which can emit a single drop size, but each addressable location on the media may have a drop placed by zero, one, or more heads. (4) The media moves below a series of print heads, which contain nozzles, each of which can deliver a single drop size, but where different nozzles can emit different drop sizes. This list is not intended to be exhaustive.

These approaches can have several challenges or difficulties. For example, there may be bleed-through or cross-talk between colorant dots or drops. In addition, print density or saturation may be limited due to these issues.

### BRIEF SUMMARY

One embodiment is a system for printing on a medium. The system includes a laser to form markings in the medium; at least one printer nozzle to produce droplets for printing on the medium; and at least one computer processor coupled to the laser and at least one printer nozzle. The at least one computer processor is configured to: receive instructions for printing on the medium; direct the laser to form an arrangement of markings in the medium in accordance with the instructions, where each marking extends into the medium; and direct the at least one printer nozzle to deposit at least one droplet of ink in each of a plurality of the markings in accordance with the instructions.

In at least some embodiments, the processor is further configured, for each of the markings, to select a depth that the marking extends into the medium. In at least some embodiments the processor is further configured, based on the instructions, to direct the laser to form a first one of the markings at a first selected depth and a second one of the markings at a second selected depth that is different from the first selected depth.

In at least some embodiments, the processor is further configured, based on the instructions, to direct the at least one printer nozzle to deposit at least one droplet of at least two different inks into at least one of the markings. In at least some embodiments, the processor is further configured, based on the instructions, to direct the at least one printer nozzle to deposit at least one droplet of a first ink into at least a first one of the markings and, after waiting a period of time, to deposit at least one droplet of a second ink into at least the first one of the markings so that the first and second inks form distinguishable layers in the first one of the markings. In at least some embodiments, the processor is further configured, based on the instructions, to direct the at least one printer nozzle to deposit a metallic ink into at least a first one of the markings and, subsequently, to deposit a non-metallic ink into at least the first one of the markings. In at least some embodiments, the processor is further configured, based on the instructions, to direct the at least one printer nozzle to deposit a color ink into at least a first one of the markings and, subsequently, to deposit a glossy ink into at least the first one of the markings.

In at least some embodiments, the processor is further configured, based on the instructions, to direct the laser to form the arrangement of the markings to correspond with a one-to-one relationship to pixels of a source image to be printed on the medium.

Another embodiment is a method of printing on a medium. The method includes using a laser to form an arrangement of markings in a medium, wherein each marking extends into the medium; and depositing at least one droplet of ink in each of a plurality of the markings using at least one printer nozzle.

In at least some embodiments, using the laser includes, for each of the markings, selecting a depth that the marking extends into the medium. In at least some embodiments, selecting a depth includes using the laser to form a first one of the markings at a first selected depth and a second one of the markings at a second selected depth that is different from the first selected depth.

In at least some embodiments, depositing at least one droplet of ink includes directing the at least one printer nozzle to deposit at least one droplet of at least two different inks into at least one of the markings. In at least some embodiments, depositing at least one droplet of ink includes directing the at least one printer nozzle to deposit at least one droplet of a first ink into at least a first one of the markings and, after waiting a period of time, depositing at least one droplet of a second ink into at least the first one of the markings so that the first and second inks form distinguishable layers in the first one of the markings. In at least some embodiments, depositing at least one droplet of ink includes directing the at least one printer nozzle to deposit a metallic ink into at least a first one of the markings and, subsequently, to deposit a non-metallic ink into at least the first one of the markings. In at least some embodiments, depositing at least one droplet of ink includes directing the at least one printer nozzle to deposit a color ink into at least a first one of the markings and, subsequently, to deposit a glossy ink into at least the first one of the markings.

In at least some embodiments, using the laser comprises using the laser to form the arrangement of the markings to correspond with a one-to-one relationship to pixels of a source image to be printed on the medium.

Yet another embodiment is a non-transitory computer-readable medium having processor-executable instructions for printing on a medium, the processor-executable instructions when installed onto a device enable the device to perform actions. The actions include receiving instructions for printing on the medium; directing a laser to form an arrangement of markings in the medium in accordance with the instructions, wherein each marking extends into the medium; and directing at least one printer nozzle to deposit at least one droplet of ink in each of a plurality of the markings in accordance with the instructions.

In at least some embodiments, the actions further include, for each of the markings, selecting a depth that the marking extends into the medium. In at least some embodiments, directing the laser includes directing the laser to form a first one of the markings at a first selected depth and a second one of the markings at a second selected depth that is different from the first selected depth.

In at least some embodiments, directing the at least one printer nozzle includes directing the at least one printer nozzle to deposit at least one droplet of at least two different inks into at least one of the markings. In at least some embodiments, directing the at least one printer nozzle includes directing the at least one printer nozzle to deposit at least one droplet of a first ink into at least a first one of the markings and, after waiting a period of time, to deposit at least one droplet of a second ink into at least the first one of the markings so that the first and second inks form distinguishable layers in the first one of the markings. In at least some embodiments, directing the at least one printer nozzle includes directing the at least one printer nozzle to deposit a metallic ink into at least a first one of the markings and, subsequently, to deposit a non-metallic ink into at least the first one of the markings. In at least some embodiments, directing the at least one printer nozzle includes directing the at least one printer nozzle to deposit a color ink into at least a first one of the markings and, subsequently, to deposit a glossy ink into at least the first one of the markings.

In at least some embodiments, directing the laser comprises directing the laser to form the arrangement of the markings to correspond with a one-to-one relationship to pixels of a source image to be printed on the medium.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic representation of one embodiment of an environment in which the invention can be employed;

FIG. 2 is a schematic representation of one embodiment of a system for laser surface preparation and inkjet printing; and

FIG. 3 is a schematic flow chart of one embodiment of preparing a surface with a laser and inkjet printing, according to the invention.

### DETAILED DESCRIPTION

The invention relates to systems and methods for printing and, in particular, inkjet printing. In addition, the invention is related to systems and methods for laser surface preparation for inkjet printing.

The methods, systems, and devices described herein may be embodied in many different forms and should not be construed as limited to the embodiments set forth herein. Accordingly, the methods, systems, and devices described herein may take the form of an entirely hardware embodiment, an entirely software embodiment, or an embodiment combining software and hardware aspects. The following detailed description is, therefore, not to be taken in a limiting sense. The methods described herein can be performed using any type of processor and any suitable type of device that includes a processor.

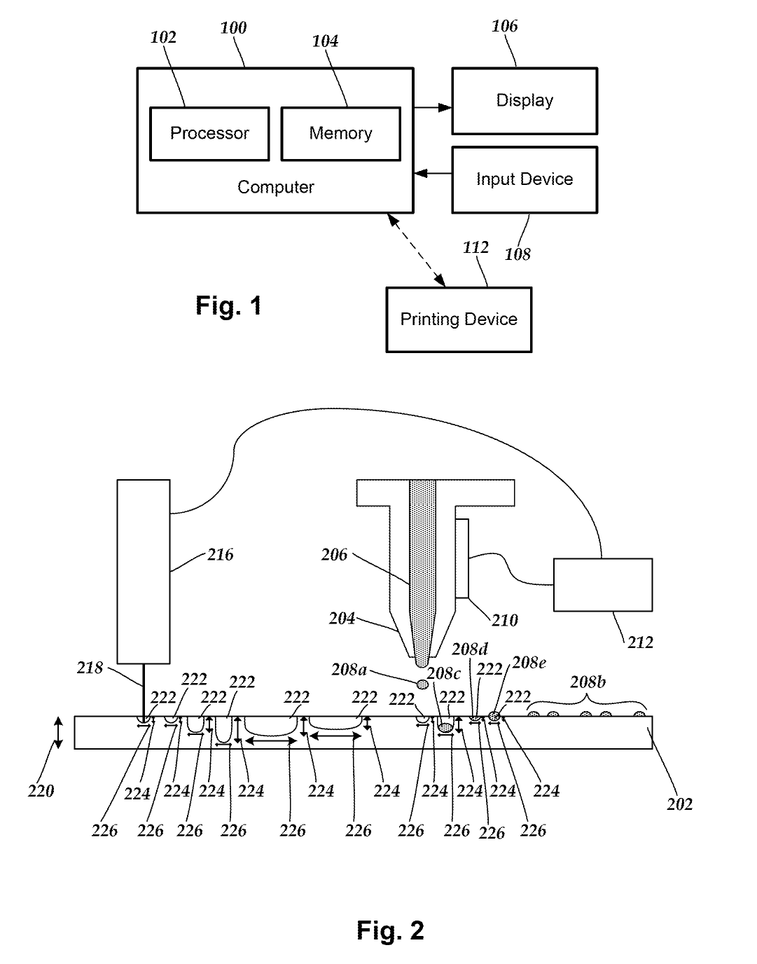

FIG. 1 illustrates one embodiment of a system for practicing the invention. The system can include a computer 100 or any other device that includes a processor 102 and a memory 104, a display 106, an input device 108, and a printing device 112, such as a printer or press.

The computer 100 can be a laptop computer, desktop computer, tablet, mobile device, smartphone or other devices that can run applications or programs, or any other suitable device for processing information and for presenting a user interface. Alternatively or additionally, the computer 100 can be part of at least one component of the printing device 112 or coupled (by wired or wireless coupling) to the printing device. The computer 100 can be local to the user or can include components that are non-local to the user including one or both of the processor 102 or memory 104 (or portions thereof). For example, in some embodiments, the user may operate a terminal that is connected to a non-local computer. In other embodiments, the memory can be non-local to the user.

The computer 100 can utilize any suitable processor 102 including one or more hardware processors that may be local to the user or non-local to the user or other components of the computer. The processor 102 is configured to execute instructions provided to the processor, as described below.

Any suitable memory 104 can be used for the computer 102. The memory 104 illustrates a type of computer-readable media, namely computer-readable storage media.

Computer-readable storage media may include, but is not limited to, nonvolatile, non-transitory, removable, and non-removable media implemented in any method or technology for storage of information, such as computer readable instructions, data structures, program modules, or other data. Examples of computer-readable storage media include RAM, ROM, EEPROM, flash memory, or other memory technology, CD-ROM, digital versatile disks (“DVD”) or other optical storage, magnetic cassettes, magnetic tape, magnetic disk storage or other magnetic storage devices, or any other medium which can be used to store the desired information and which can be accessed by a computer.

Communication methods provide another type of computer readable media; namely communication media. Communication media typically embodies computer-readable instructions, data structures, program modules, or other data in a modulated data signal such as a carrier wave, data signal, or other transport mechanism and include any information delivery media. The terms “modulated data signal” and “carrier-wave signal” include a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

The display 106 can be any suitable display device, such as a monitor, screen, display, or the like. The input device 108 can be, for example, a keyboard, mouse, touch screen, track ball, joystick, voice recognition system, or any combination thereof, or the like and can be used by the user to interact with a user interface.

FIG. 2 illustrates one example of a system for laser surface preparation and inkjet printing and includes an inkjet printer nozzle 204, laser 216, and a controller 212. The laser surface preparation and inkjet printing may be performed on a medium 202, such as wood, glass, stone, jewels, rubber, plastic, metal, paper, or the like. The inkjet printer nozzle 204 (for example, a digital inkjet printer nozzle) dispenses ink 206 via droplets 208a onto the medium 202. A drop creation element 204 creates droplets 208a from a reservoir 206 of ink. Examples of the drop creation element 210 include, but are not limited to, heating elements, piezo elements, or the like. A controller 212, such as computer 100 of FIG. 1, controls the operation and movement of the nozzle 204 and the laser 216. The controller 212 directs the nozzle 204 to propel the droplets 208a onto the medium 202 in particular patterns along the medium 202 according to instructions provided to the controller 212. Examples of controls include movement of the nozzle 204 along the medium 202, variation in the number or volume of the droplets 208a, color of the ink 206 that is dispensed, or the like.

To facilitate better printing, a laser 216 emits a laser beam 218 to produce markings 222 (e.g., cavities, pits, indents, or holes) in the medium 202 by removing a portion of the medium 202 to form the markings 222. The markings 222 can then receive one or more droplets 208a from the inkjet printer nozzle 204. Any suitable type of laser 216 can be used, including, but not limited to, gas (for example, carbon dioxide), chemical, dye, metal-vapor, solid-state (for example, neodymium-doped yttrium aluminum garnet (YAG) lasers), semiconductor, or other types of lasers. A different type of laser 216 may be selected based on the type of material of the medium 202. For example, a carbon dioxide laser with a wavelength of 10.64 microns may be selected for a medium 202 that includes organic materials such as wood, acrylic, rubber, other non-metallic materials, or coatings on metals, such as painted brass, anodized aluminum, or another coating. As another example, a YAG laser with a wavelength of 1.064 microns may be selected for a medium 202 that includes metals or plastics. In some embodiments, the controller 212 may control the laser 216 to vary the intensity, wavelength, size, position, angle, pulse duration, or the like of the laser beam 218 to produce markings 222 of different sizes or shapes. In some embodiments, the controller 212 may control the laser 216 to produce uniform markings 222. The markings can be used to provide uniform (or non-uniform) round dots more reliably than convention inkjet printing.

The laser 216 produces multiple discrete markings 222 in the medium 202. In some embodiments, the discrete markings 222 correspond to individual pixels that will receive one or more droplets 208a of ink. In other embodiments, a marking 222 made by the laser 216 can extend between multiple pixels. In some embodiments, the markings 222 are uniform (within a particular degree of tolerance) in depth, width, and shape. In other embodiments, the markings 222 may have different depths 224, widths 226, or shapes, as illustrated by the different markings 222 in FIG. 2.

Although the depth axis of each marking 222 shown in FIG. 2 is parallel to the height axis 220 of the medium 202, other examples include markings 222 that extend (e.g., have depth axes that are oriented) at acute or oblique angles to the height axis 220 of the medium 202. Markings 222 that extend at acute or oblique angles to the height axis 220 of the medium 202 may be employed to create a metallic effect with non-metallic inks. For example, the markings 222 may be angled and arranged to provide a goniometric effect that, from a viewer perspective, facilitates a metallic effect when the markings 222 are at least partially filled with one or more non-metallic inks. Also, the interior surface of a marking 222 can have a variety of different textures etched into different portions of the surface of the marking 222 by the laser beam 218 to provide a different reflection based on the angle or direction from which the marking 222 is viewed. As another example, etching the surfaces of the markings may facilitate structural coloration.

Conventional inkjet printing with metallic inks may be severely limited because the size of the metallic particles/fillings/filaments (often referred to as nanoparticles) are difficult to eject and jetting metallic inks through nozzles of an inkjet cartridge/pen/print-head without clogging can be a major challenge. The typical approach to addressing these challenges is to reduce the size of the metallic particles. In contrast, providing markings 222 that extend at acute or oblique angles to the height axis 220 of the medium 202 or that have etched textures may address these challenges by providing a metallic effect without using metallic ink.

In addition, the markings 222 may be produced along one or more sidewalls of the medium 202 (as opposed to along the top of the medium 202 as shown in FIG. 2) and may extend at acute angles, at oblique angles, or perpendicular to the height axis 220 of the medium 202. Typically, ink droplets 208 that have been inkjet printed onto a sidewall, such as a sidewall of a three-dimensional-printed (3D printed) model (for example, a plastic or metallic model), have a tendency to run downward along the sidewall due to gravity. In contrast, producing the laser-ablated markings 222 along a sidewall, such as a sidewall of a 3D printed model, may facilitate retention of ink droplets 208 at the locations of the markings 222 in which the droplets 208 were deposited. Providing markings 222 that extend into the sidewall of the medium 202 at acute or oblique angles to the height axis 220 of the medium 202 may facilitate retaining the droplets 208 and also may facilitate providing a metallic effect without using metallic inks. FIG. 2 also illustrates ink droplets 208b conventionally deposited by the nozzle 204 onto the original surface of the medium 202 prior to marking by the laser 216. In at least some instances, the ink may wick or be absorbed by the medium and will eventually dry on the medium.

In contrast, when the laser 216 first forms markings 222 in the medium 205, the nozzle 204 then deposits one or more ink droplets 208a into the markings 222. In at least some embodiments, the printing device will have more than one nozzle and the multiple nozzles may deposit different types or colors of ink or may deposit droplets in multiple spaces simultaneously. An advantage of using a laser to produce markings is that this may facilitate printing on materials that may be difficult to otherwise print on, such as, for example, polyvinyl chloride (PVC). The systems and methods utilizing lasers to produce markings can also reduce or eliminate bleeding or dot-to-dot interactions, color moire, or cross-talk between colorants/inks. As compared to conventional inkjet printing, these systems and methods may produce a flatter ink-dot surface, reduce or eliminate dot-off-dot interaction, produce more controllable dot-on-dot interaction, or the like.

In some embodiments or some instances, one or more ink droplets 208c are deposited by the nozzle 204 into a marking 222 that has a volume that exceeds the volume of the one or more ink droplets 208c. In some embodiments or some instances, one or more ink droplets 208d may be deposited by the nozzle 204 into a marking 222 that has a volume that matches (at least within a degree of tolerance) the volume of the one or more ink droplets 208d. In some embodiments or some instances, one or more ink droplets 208e are deposited by the nozzle 204 into a marking 222 that has a volume that is exceeded by the volume of the one or more ink droplets 208e. In some embodiments, a system or method may utilize any combination of these three cases. These different cases may produce different ink depths or color depths. Using the laser and markings may facilitate achieving higher print densities or saturation. For example, the depth of the markings 222 may be increased or varied to allow the deposition of more ink. In conventional printing, ink droplets 208b on a surface of a medium 202 may overflow beyond the areas that the ink droplets 208b are intended to cover on the surface of the medium 202. In contrast, the markings 222 facilitate controlling or preventing overgrowth or overflow of ink beyond the outer perimeters of the markings 222 and may also provide a smoother top surface, thereby providing true dot-off-dot printing and reducing color moire.

In at least some embodiments, markings 222 that overlap or otherwise touch each other have different depths. Specified amounts of the same or different inks may be deposited in the overlapping markings 222. In some examples, ink from a higher elevation (i.e., more shallow) portions of the overlapping markings 222 may seep or flow to mix with ink at deeper portions of the overlapping markings 222. In contrast, the ink in the deeper marking may not transfer over to the shallower marking, thereby reducing or preventing mixing in the shallower marking2. Accordingly, the respective depths of adjoining markings 222 can facilitate controlling the direction of mixing inks to provide a controllable dot-on-dot interaction. In at least some embodiments, markings 222 are formed to have square or rectangular perimeter (or nearly square or rectangular, such as with rounded corners) and to correspond with a one-to-one relationship to pixels of a source image to be printed on the medium 202. Markings 222 having a one-to-one relationship to pixels of a source image may be referred to as picture square elements (PicSEls). PicSEls may facilitate storing, displaying, or printing digital data represented in pixels per inch (PPI) instead of dots per inch (DPI) or lines per inch (LPI) as in conventional printing. Accordingly, PicSEls may facilitate printing the source image without a raster image processor (RIP) processing a pixel-based raster (for example, a bitmap) or vector data to raster data or ink dot placement maps (such as halftones or screens), thereby permitting faster and more cost effective printing. Moreover, PicSEls may facilitate easier soft proofing.

In at least some embodiments, one, two, three, four, five, or more droplets 208a may be deposited into a single marking 222. In at least some embodiments, droplets 208a of two, three, four, five, or more different colors or ink types may be deposited into a single marking 222. Use of different colored inks in the same marking can allow for additive color printing in addition to conventional subtractive color printing. When using white paper as a medium in conventional printing, ink printed on the paper filters wavelengths of light otherwise reflected from the paper to subtractively control the color of reflected light (for example, process colors). In contrast, the markings 222 facilitate directly mixing colors without considering the non-process colors' roles in subtracting specific wavelengths from light reflected from the medium 202 (for example, non-process or spot colors). Instead, when mixing the non-process colors, a user can focus on the addition of wavelengths of light by the non-process colors, thereby facilitating a direct and intuitive color mixing process. When employing PicSEls, employing additive color printing facilitates using the same color management techniques as used in electronic display devices, thereby permitting simplification of processing a digital source image.

In at least some embodiments, droplets 208a of different colors or ink types can be layered in a single marking 222. When the ink is allowed to partially or fully dry, laminar printing, with layers that do not physically seep into each other, can be performed. In one example, metallic inks can be printed underneath another color layer. This can be useful, for example, in goniochromatic printing, pearlescent printing, or iridescent printing.

For example, a silver metallic ink droplet 208 can be deposited in a marking 222, and, after the silver metallic ink droplet 208 at least partially dries, one or more transparent or semi-transparent ink droplets 208 (for example, varnish or clear inks) can be deposited in the marking 222 (for example, a cyan non-metallic ink droplet 208 and a yellow metallic ink droplet 208 can be deposited in the marking 222 to produce a green metallic dot). In this example, the silver metallic ink droplet 208 may have a volume that is the same as or less than the volume of the marking 222, and the cyan and yellow droplets 208 may overflow or extend above the marking 222. Also in this example, each marking 222 could have a different color mix at different depths to facilitate producing different visual effects (for example, iridescent prints). As another example, the markings 222 may be produced to extend at acute or oblique angles to the height axis 220 of the medium 202, instead of or in addition to employing the silver metallic ink droplet 208, to facilitate the iridescent print when the cyan and yellow droplets 208 overflow or extend above the marking 222. Accordingly, the markings 222 may facilitate providing directional (goniometric) reflections or refractions (for example, changes in the wavelength or color of the reflected light). In some examples, producing markings 222 that have different depths for each color may facilitate selecting directions or angles from which specific reflections or refractions may be viewed.

As other examples, autostereoscopic printing and lenticular printing can be performed using these systems and methods. In at least some examples, the laser beam 218 produces rows of markings 222 that have different depths or angles of extension into the medium 202 to facilitate producing a lenticular effect based on different subsets of ink droplets 208 being visible from different directions or angles. In some of cases, ink can be built up in the rows of markings 222 to heights above the surface of the medium 202. An example of the rows of markings 222 includes directional grooves (for example, a marking 222 that is a continuous groove may extend into the medium 202 at an angle that is offset from the height axis 220 of the medium 222 such that the surfaces of the marking 222 are viewable from a narrow range of directions or angles) to facilitate creating a movement parallax where viewable texture changes based on the viewing angle or direction of an observer. In some cases, markings 222 in the same or different areas on the medium 202 can be arranged in patterns to facilitate reflection of different information to observers viewing from different directions or angles (for example, a static parallax effect). In some examples of producing the static parallax effect, the markings 222 can be arranged to reflect different content based on where on the area on the surface of the medium 202 that an observer's eyes focus. In some embodiments, these systems and methods can be used to produce or enhance animation. In some embodiments, the different amounts of ink in different markings may be used to generate a textured surface in the medium.

These systems and methods may also produce greater light fastness in fluorescent printing or produce a gloss when color printing. By employing various amounts of ink in the markings 222 to facilitate different heights of ink droplets 208 (for example, some markings 222 may hold a greater volume of ink than the volume of the markings 222, and other markings 222 may hold a lower volume of ink than the volume of the other markings 222), surface textures can be simulated (for example, an orange peel surface or sand). In some examples, clear ink (or varnish) may be deposited over and above the markings 222 to produce clear-ink bumps to facilitate a lens effect (for example, over a single marking 222 or a group of markings 222). In some cases, a clear-ink bump may magnify one or more colors or patterns disposed beneath the clear-ink bump. Also in some cases, a clear-ink bump may facilitate enlarging a number of directions or angles from which one or more colors or patterns disposed beneath the clear-ink bump are visible. Accordingly, different locations on the surface of the medium 202 can be selected for magnification. In some examples, one or more clear-ink bumps can be quickly cured with ultraviolet (UV) light during the printing process to enhance a lens effect provided by the one or more clear-ink bumps.

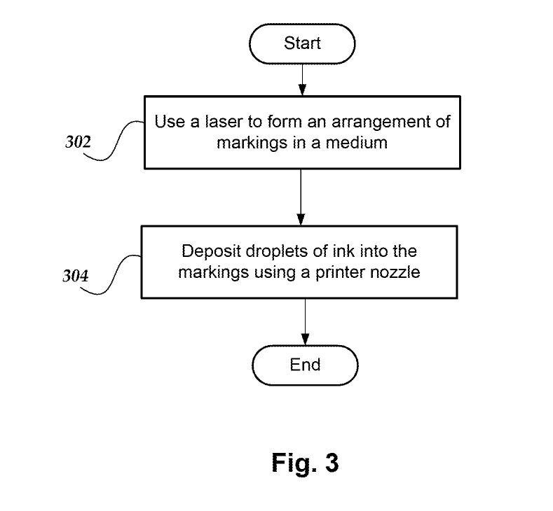

In at least some embodiments, clear ink or varnish can be deposited over fluorescent ink droplets 208 in markings 222. Although fluorescent inks in conventional printing typically suffer from weak light fastness (for example, fluorescent inks typically quickly fade due to various factors such as ambient humidity, ambient light, or other environmental conditions), the markings 222 can facilitate employing clear ink over fluorescent ink droplets 208 in the markings 222 to protect the fluorescent ink. For example, traffic signs or outdoor advertisements can be produced using these systems and methods. FIG. 3 illustrates one embodiment of a method of printing with a laser inkjet nozzle. In step 302, a laser (for example, the laser 216) emits a laser beam to form an arrangement of markings in a medium. In at least some embodiments, the arrangement of the markings is based on instructions received by the printing device or controller operating the laser. These instructions may be provided directly by a user or by a raster or other device (which may be different from, or part of, the printing device or controller) that produces printing instructions.

In step 304, a printer nozzle deposits droplets of ink in the markings. In at least some embodiments, the arrangement of the markings is based on the instructions provided by the user, raster, or other device. The printer nozzle may deposit one or more droplets of ink in a marking. Some markings may not receive droplets. In some embodiments, one or more droplets of each of two or more different inks may be deposited in a marking.

It will be understood that each block of the flowchart illustration, and combinations of blocks in the flowchart illustration and methods disclosed herein, can be implemented by computer program instructions. These program instructions may be provided to a processor to produce a machine, such that the instructions, which execute on the processor, create means for implementing the actions specified in the flowchart block or blocks disclosed herein. The computer program instructions may be executed by a processor to cause a series of operational steps to be performed by the processor to produce a computer implemented process. The computer program instructions may also cause at least some of the operational steps to be performed in parallel. Moreover, some of the steps may also be performed across more than one processor, such as might arise in a multi-processor computer system. In addition, one or more processes may also be performed concurrently with other processes, or even in a different sequence than illustrated without departing from the scope or spirit of the invention.

The computer program instructions can be stored on any suitable computer-readable medium including, but not limited to, RAM, ROM, EEPROM, flash memory or other memory technology, CD-ROM, digital versatile disks (“DVD”) or other optical storage, magnetic cassettes, magnetic tape, magnetic disk storage or other magnetic storage devices, or any other medium which can be used to store the desired information and which can be accessed by a computer.

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A system for printing on a medium, the system comprising:
a laser configured and arranged to form markings in the medium;
at least one printer nozzle configured and arranged to produce droplets for printing on the medium; and
at least one computer processor coupled to the laser and at least one printer nozzle, wherein the at least one computer processor is configured to:
receive instructions for printing on the medium;
direct the laser to form an arrangement of markings in the medium in accordance with the instructions, wherein each marking extends into the medium; and
direct the at least one printer nozzle to deposit at least one droplet of ink in each of a plurality of the markings in accordance with the instructions.

2. The system of claim 1, wherein the processor is further configured, for each of the markings, to select a depth that the marking extends into the medium.

3. The system of claim 2, wherein the processor is further configured, based on the instructions, to direct the laser to form a first one of the markings at a first selected depth and a second one of the markings at a second selected depth that is different from the first selected depth.

4. The system of claim 1, wherein the processor is further configured, based on the instructions, to direct the at least one printer nozzle to deposit at least one droplet of at least two different inks into at least one of the markings.

5. The system of claim 4, wherein the processor is further configured, based on the instructions, to direct the at least one printer nozzle to deposit at least one droplet of a first ink into at least a first one of the markings and, after waiting a period of time, to deposit at least one droplet of a second ink into at least the first one of the markings so that the first and second inks form distinguishable layers in the first one of the markings.

6. The system of claim 4, wherein the processor is further configured, based on the instructions, to direct the at least one printer nozzle to deposit a metallic ink into at least a first one of the markings and, subsequently, to deposit a non-metallic ink into at least the first one of the markings.

7. The system of claim 4, wherein the processor is further configured, based on the instructions, to direct the at least one printer nozzle to deposit a color ink into at least a first one of the markings and, subsequently, to deposit a glossy ink into at least the first one of the markings.

8. The system of claim 1, wherein the processor is further configured, based on the instructions, to direct the laser to form the arrangement of the markings to correspond with a one-to-one relationship to pixels of a source image to be printed on the medium.

9. A method of printing on a medium, the method comprising:
using a laser to form an arrangement of markings in a medium, wherein each marking extends into the medium; and
depositing at least one droplet of ink in each of a plurality of the markings using at least one printer nozzle.

10. The method of claim 9, wherein using the laser comprises, for each of the markings, selecting a depth that the marking extends into the medium.

11. The method of claim 10, wherein selecting a depth comprises using the laser to form a first one of the markings at a first selected depth and a second one of the markings at a second selected depth that is different from the first selected depth.

12. The method of claim 9, wherein depositing at least one droplet of ink comprises directing the at least one printer nozzle to deposit at least one droplet of at least two different inks into at least one of the markings.

13. The method of claim 9, wherein depositing at least one droplet of ink comprises directing the at least one printer nozzle to deposit at least one droplet of a first ink into at least a first one of the markings and, after waiting a period of time, depositing at least one droplet of a second ink into at least the first one of the markings so that the first and second inks form distinguishable layers in the first one of the markings.

14. The method of claim 9, wherein depositing at least one droplet of ink comprises directing the at least one printer nozzle to deposit a metallic ink into at least a first one of the markings and, subsequently, to deposit a non-metallic ink into at least the first one of the markings.

15. The method of claim 9, wherein depositing at least one droplet of ink comprises directing the at least one printer nozzle to deposit a color ink into at least a first one of the markings and, subsequently, to deposit a glossy ink into at least the first one of the markings.

16. The method of claim 9, wherein using the laser comprises using the laser to form the arrangement of the markings to correspond with a one-to-one relationship to pixels of a source image to be printed on the medium.

17. A non-transitory computer-readable medium having processor-executable instructions for printing on a medium, the processor-executable instructions when installed onto a device enable the device to perform actions, including:
receiving instructions for printing on the medium;
directing a laser to form an arrangement of markings in the medium in accordance with the instructions, wherein each marking extends into the medium; and
directing at least one printer nozzle to deposit at least one droplet of ink in each of a plurality of the markings in accordance with the instructions.

18. The non-transitory computer-readable medium of claim 17, wherein the actions further comprise, for each of the markings, selecting a depth that the marking extends into the medium.

19. The non-transitory computer-readable medium of claim 17, wherein directing the laser comprises directing the laser to form a first one of the markings at a first selected depth and a second one of the markings at a second selected depth that is different from the first selected depth.

20. The non-transitory computer-readable medium of claim 17, wherein directing the at least one printer nozzle comprises directing the at least one printer nozzle to deposit at least one droplet of at least two different inks into at least one of the markings.

21. The non-transitory computer-readable medium of claim 17, wherein directing the at least one printer nozzle comprises directing the at least one printer nozzle to deposit at least one droplet of a first ink into at least a first one of the markings and, after waiting a period of time, to deposit at least one droplet of a second ink into at least the first one of the markings so that the first and second inks form distinguishable layers in the first one of the markings.

22. The non-transitory computer-readable medium of claim 17, wherein directing the at least one printer nozzle comprises directing the at least one printer nozzle to deposit a metallic ink into at least a first one of the markings and, subsequently, to deposit a non-metallic ink into at least the first one of the markings.

23. The non-transitory computer-readable medium of claim 17, wherein directing the at least one printer nozzle comprises directing the at least one printer nozzle to deposit a color ink into at least a first one of the markings and, subsequently, to deposit a glossy ink into at least the first one of the markings.

24. The non-transitory computer-readable medium of claim 17, wherein directing the laser comprises directing the laser to form the arrangement of the markings to correspond with a one-to-one relationship to pixels of a source image to be printed on the medium.
